(19) United States
(12) Patent Application Publication
(10) Pub. No.: US 2018/0088786 A1
(43) Pub. Date: Mar. 29, 2018

(54) CAPACITIVE TOUCH MAPPING

(71) Applicant: Microsoft Technology Licensing, LLC, Redmond, WA (US)

(72) Inventors: David ABZARIAN, Kenmore, WA (US); Fei SU, Issaquah, WA (US); Austin Bradley HODGES, Seattle, WA (US); Silvano BONACINA, Redmond, WA (US); Andrew Pyon MITTEREDER, Seattle, WA (US); Reed Lincoln TOWNSEND, Kirkland, WA (US); Kyle Thomas BECK, Redmond, WA (US)

(73) Assignee: Microsoft Technology Licensing, LLC, Redmond, WA (US)

(21) Appl. No.: 15/660,679

(22) Filed: Jul. 26, 2017

Related U.S. Application Data
(60) Provisional application No. 62/399,224, filed on Sep. 23, 2016.

(51) Int. Cl. G06F 3/0484; G06F 3/044; G06F 3/0488; G06F 3/0354; G06N 99/00

(52) U.S. Cl. CPC G06F 3/04845; G06F 3/044; G06N 99/005; G06F 3/03545; G06F 3/04883

(57) ABSTRACT

A computing system includes a capacitive touch-display including a plurality of touch-sensing pixels, a digitizer configured to generate a capacitive grid map including a capacitance value for each of the plurality of touch-sensing pixels, and an operating system configured to receive the capacitive grid map directly from the digitizer.

### CROSS REFERENCE TO RELATED APPLICATIONS

This application claims priority to U.S. Provisional Patent Application No. 62/399,224, filed Sep. 23, 2016, the entirety of which is hereby incorporated herein by reference.

### BACKGROUND

Computing devices often include displays that utilize capacitive sensors to enable touch and multi-touch functionality. More specifically, state of the art computing devices utilize firmware that distills raw measurements from the capacitive sensors into a limited collection of resultant individual touch points. Each touch point, although derived from a complex dataset of capacitance values, is typically distilled to a two-dimensional screen coordinate (e.g., a single horizontal coordinate and a single vertical coordinate defining the location of a finger touch on the display).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A computing system includes a capacitive touch-display including a plurality of touch-sensing pixels, a digitizer configured to generate a capacitive grid map including a capacitance value for each of the plurality of touch-sensing pixels, and an operating system configured to receive the capacitive grid map directly from the digitizer.

### BRIEF DESCRIPTION OF THE DRAWINGS

FIG. 1 schematically shows an example computing system including a display device and a capacitive touch sensor.

FIG. 2 schematically shows an example computing architecture in which an operating system of a computing device is exposed to a capacitive grid map of a capacitive touch sensor.

FIG. 3 schematically shows an example capacitive grid map.

FIG. 4 schematically shows an example capacitive grid map data structure.

FIG. 5 schematically shows an example machine-learning classifier hierarchy for recognizing touch profiles of different types of touch input from capacitive grid maps.

FIGS. 6-7 show different example touch profiles including an intentional-touch portion and an unintentional-touch portion.

FIGS. 8-12 show example scenarios of adjusting presentation, via a display, of a graphical user interface object based on analysis of a capacitive grid map of a capacitive touch sensor.

FIG. 13 shows an example method for controlling operation of a computing device using an operating system that is informed by a capacitive grid map of a capacitive touch sensor.

FIG. 14 shows an example computing system.

### DETAILED DESCRIPTION

Some computing devices include capacitive sensors to enable touch and multi-touch functionality. More specifically, such touch-sensitive computing devices typically utilize firmware that distill raw measurements from the capacitive sensors into a limited collection of resultant individual touch points. Each touch point, although derived from a complex dataset of capacitance values, is typically distilled to a two-dimensional screen coordinate (e.g., a single horizontal coordinate and a single vertical coordinate defining the location of a finger touch on the display). In some implementations, a width, height, and/or orientation may be associated with each two-dimensional coordinate. Only these resultant individual touch points are exposed to the Operating System (OS) and/or applications. This limits the types of user interactions that can be supported to only those interactions that map to simplistic touch point coordinates.

When a touch input area is not identified/exposed to the OS, the OS is not aware that the user is touching that area of the display because the firmware simply does not report any touch input information for that area (e.g., to avoid operation based on unintentional touch input). However, such information relating to unintentional (e.g., non-finger) touch input may be useful. For example, the OS may determine contextual information about the type of touch input being provided to the capacitive touch sensor based on such information.

Accordingly, the present disclosure relates to an approach for controlling operation of a computing device using an operating system that is exposed to and informed by a full capacitive grid map of a capacitive touch sensor. The capacitive grid map includes capacitance values for each touch-sensing pixel of a set of touch-sensing pixels of the capacitive touch sensor. The capacitive grid map is provided to the operating system directly from the touch-sensing digitizer (i.e., without firmware first distilling the raw touch data into touch points. By exposing the full touch data set to the operating system without unnecessary processing delays, the operating system is able to provide more rewarding user experiences. More particularly, the operating system may be configured to visually present a user interface object and/or adjust presentation of the user interface object based on analysis of the capacitance values of the capacitive grid map.

By analyzing the capacitive grid map and not just individual touch points, the operating system may improve a variety of different user interactions. For example, analysis of the capacitive grid map may enable various gestures to be recognized that otherwise would not be recognized from individual touch points. In another example, the capacitive grid map may be used to differentiate between different sources of touch input (e.g., finger, stylus, and other types of objects), and provide different source-specific responses based on recognizing the different touch-input sources. In still another example, user interactions may be optimized by virtue of understanding how a user is holding or interacting with the computing device based on analysis of the capacitive grid map.

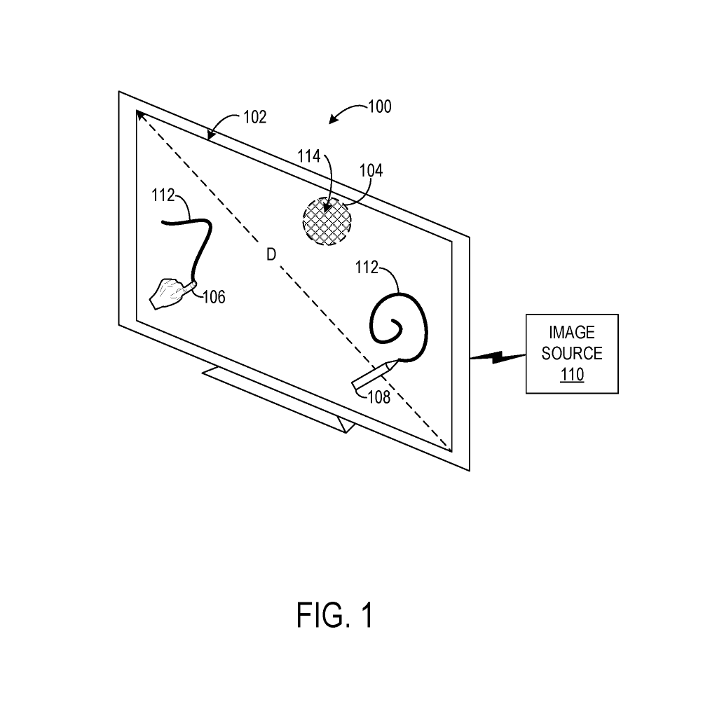

FIG. 1 shows a computing system 100 including a display 102 and a capacitive touch sensor 104. In some examples, display 102 may be a large-format display with a diagonal dimension D greater than 1 meter, though the display may assume any suitable size. Computing system 100 may be implemented in a variety of forms. In other examples, computing device 100 may be a mobile device (e.g., tablet, smartphone) with a diagonal dimension on the order of inches. Other suitable forms are contemplated, including but not limited to desktop display monitors, high-definition television screens, tablet devices, laptop computers, etc.

Capacitive touch sensor 104 may be configured to sense one or more sources of input, such as touch input imparted via fingers 106 and/or input supplied by an input device 108, shown in FIG. 1 as a stylus. The stylus 108 may be passive or active. An active stylus may include an electrode configured to transmit a waveform that is received by the capacitive touch sensor 104 to determine a position of the active stylus. The fingers 106 and input device 108 are provided as non-limiting examples, and any other suitable source of input may be used in connection with display 102.

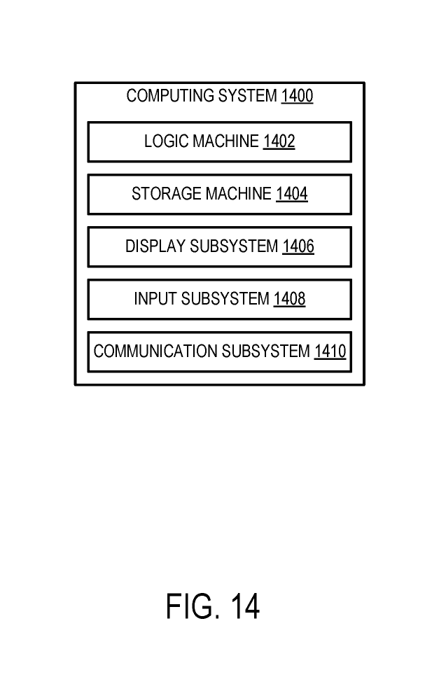

Display 102 may be operatively coupled to an image source 110, which may be, for example, a computing device external to, or housed within, the display. Image source 110 may receive input from display 102, process the input, and in response generate appropriate graphical output in the form of user interface objects 112 for the display. In this way, display 102 may provide a natural paradigm for interacting with a computing device that can respond appropriately to touch input. Details regarding an example computing system are described below with reference to FIG. 14.

Display 102 is operable to emit light, such that perceptible images can be formed at a surface of the display or at other apparent location(s). For example, display 102 may assume the form of a liquid crystal display (LCD), organic light-emitting diode display (OLED), or any other suitable display. To effect display operation, image source 110 may control pixel operation, refresh rate, drive electronics, operation of a backlight if included, and/or other aspects of the display. In this way, image source 110 may provide graphical content for output by display 102.

Capacitive touch sensor 104 is operable to receive input, which may assume various suitable form(s). As examples, capacitive touch sensor 104 may detect (1) touch input applied by the human finger 106 in contact with a surface of display 102; (2) a force and/or pressure applied by the finger 106 to the surface; (3) hover input applied by the finger 106 proximate to but not in contact with the surface; (4) a height of the hovering finger 106 from the surface, such that a substantially continuous range of heights from the surface can be determined; and/or (5) input from a non-finger touch source, such as from active stylus 108. “Touch input” as used herein refers to both finger and non-finger (e.g., stylus) input, and to input supplied by input devices both in contact with, and spaced away from but proximate to, display 102. Capacitive touch sensor 104 may be configured to receive input from multiple input sources (e.g., digits, styluses, other input devices) simultaneously, and thus may be referred to as a “multi-touch” display device. To enable input reception, capacitive touch sensor 104 may be configured to detect changes associated with the capacitance of a plurality of electrodes 114 of the touch sensor 104, as described in further detail below. Touch inputs (and/or other information) received by touch sensor 104 are operable to affect any suitable aspect of display 102 and/or computing device 100, and may include two or three-dimensional finger inputs and/or gestures.

Capacitive touch sensor 104 may take any suitable form. In some examples capacitive touch sensor 104 may be integrated within display 102 in a so-called “in-cell” touch sensor implementation. In this example, one or more components of display 102 may be operated to perform both display output and touch input sensing functions. As a particular example, the same physical electrical structure may be used both for capacitive touch sensing and for determining the field in the liquid crystal material that rotates polarization to form a displayed image. Alternative or additional components of display 102 may be employed for display and input sensing functions, however.

Other touch sensor configurations are possible. For example, capacitive touch sensor 104 may alternatively be implemented in a so-called “on-cell” configuration, in which the touch sensor 104 is disposed directly on display 102. In an example on-cell configuration, touch sensing electrodes 114 may be arranged on a color filter substrate of display 102. Implementations in which the capacitive touch sensor 104 is configured neither as an in-cell nor on-cell sensor are possible, however.

Capacitive touch sensor 104 may be configured in various structural forms. For example, the plurality of electrodes (also referred to as touch-sensing pixels) 114 may assume a variety of suitable forms, including but not limited to (1) elongate traces, as in row/column electrode configurations, where the rows and columns are arranged at substantially perpendicular or oblique angles to one another; (2) substantially contiguous pads/pixels, as in mutual capacitance configurations in which the pads/pixels are arranged in a substantially common plane and partitioned into drive and receive electrode subsets, or as in in-cell or on-cell configurations; (3) meshes; and (4) an array of isolated (e.g., planar and/or rectangular) electrodes each arranged at respective x/y locations, as in in-cell or on-cell configurations.

Capacitive touch sensor 104 may be configured for operation in different modes of capacitive sensing. In a self-capacitance mode, the capacitance and/or other electrical properties (e.g., voltage, charge) between touch sensing electrodes and ground may be measured to detect inputs. In other words, properties of the electrode itself are measured, rather than in relation to another electrode in the capacitance measuring system. In a mutual capacitance mode, the capacitance and/or other electrical properties between electrodes of differing electrical state may be measured to detect inputs. When configured for mutual capacitance sensing, and similar to the above examples, the capacitive touch sensor 104 may include a plurality of vertically separated row and column electrodes that form capacitive, plate-like nodes at row/column intersections when the touch sensor is driven. The capacitance and/or other electrical properties of the nodes can be measured to detect inputs.

For self-capacitance implementations, the capacitive touch sensor 104 may analyze one or more electrode characteristics to identify the presence of an input source. Typically, this is implemented via driving an electrode with a drive signal, and observing the electrical behavior with receive circuitry attached to the electrode. For example, charge accumulation at the electrodes resulting from drive signal application can be analyzed to ascertain the presence of the input source. In these example methods, input sources of the types that influence measurable properties of electrodes can be identified and differentiated from one another, such as human digits, styluses, and other physical object which may affect electrode conditions by providing a capacitive path to ground for electromagnetic fields. Other methods may be used to identify different input source types, such as those with active electronics.

As will be discussed in further detail below, a digitizer may be configured to output a capacitive grid map based on capacitance measurements at each touch-sensing pixel 114 of the touch sensor 104. The digitizer may represent the capacitance of each pixel with a binary number having a selected bit depth. For example, an eight bit number may be used to represent 256 different capacitances. The capacitive grid map may be used to present appropriate graphical output and improve a variety of different user interactions.

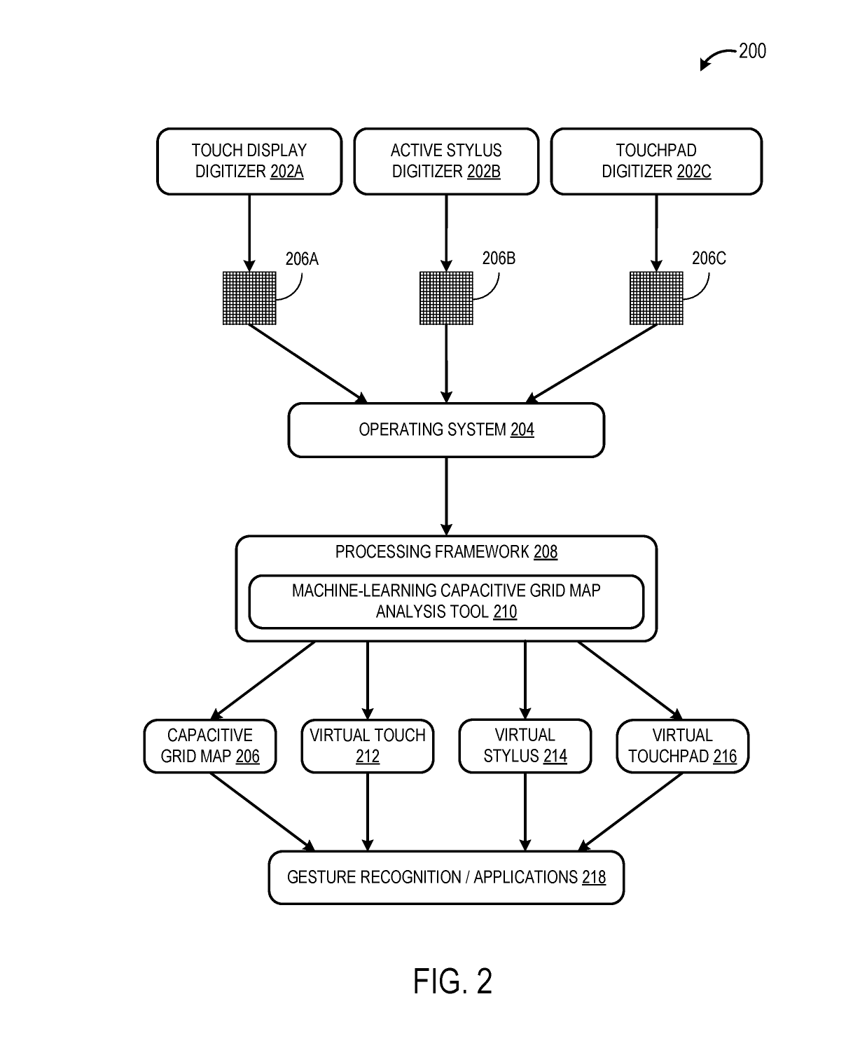

FIG. 2 schematically shows an example computing architecture 200 that may be implemented by a computing system, such as the computing system 100 of FIG. 1. Computing architecture 200 may utilize one or more capacitive touch sensors/digitizers 202 (e.g., touch-display digitizer 202A, active stylus digitizer 202B, and touchpad digitizer 202C) and a framework for exposing a robust set of capacitance value data to an operating system (OS) 204 and/or applications executed by the computing system. Touch sensors/digitizers 202 may be configured to communicate capacitance values in the form of capacitive grid maps 206 (e.g., capacitive grid map 206A from touch-display digitizer 202A, capacitive grid map 206B from active stylus digitizer 202B, and/or capacitive grid map 206C from touchpad digitizer 202C) from hardware sensors (e.g., a capacitive sensing matrix) directly to the OS 204. Depending on the touch-sensing capabilities of the computing system hardware, the OS 204 may receive one or more of the capacitive grid maps 206. The OS 204 may be configured to communicate the capacitive grid map(s) 206 to other OS components and/or applications 218, process the raw capacitive grid map(s) 206 for downstream consumption, and/or log the capacitive grid map(s) 206 for subsequent use. The capacitive grid map(s) 206 received by the OS 204 provide a full complement of capacitance values measured by the capacitive sensors.

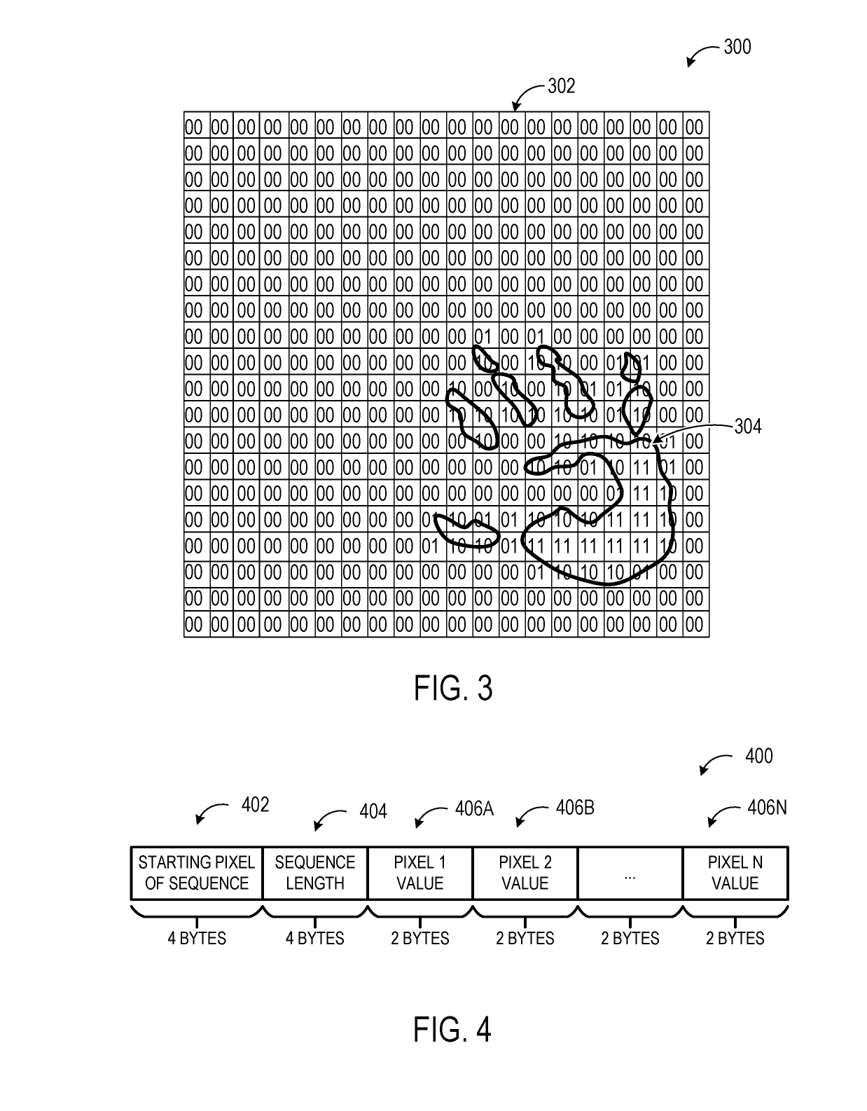

FIG. 3 shows a visual representation of a simplified capacitive grid map 300 in the form of a two-dimensional matrix that includes, for each cell 302 of the matrix, a capacitance measurement. Each cell 302 of the matrix corresponds to a different area of the touch sensor. Each area may be referred to as a touch-sensing pixel or node of the touch sensor. The resolution of the touch-sensing pixels may be the same as, or different than, the resolution of light-emitting display pixels. Each cell 302 may have any desired bit depth. As an example, a cell with a bit depth of two may detail four different capacitance measurements (i.e., 00, 01, 10, and 11) corresponding to four different capacitance magnitudes measured at the corresponding touch sensing pixel. Any suitable data structure(s) may be used to represent the capacitive grid map 300.

In the example of FIG. 3, the capacitive grid map 300 includes a 20×20 matrix, and each cell of the matrix includes a two-bit capacitance measurement. For example, cell 302 includes a capacitance measurement of “00.” In practice, higher (or lower) resolutions and higher (or lower) bit depths may be used. FIG. 3 also shows a touch profile 304 characterizing a shape of touch input to the capacitive touch sensor based on the capacitance values in the cells 302 of the capacitive grid map 300. The touch profile 304 represents an outline of a hand print representing an example user touch on a touch sensor. As shown in FIG. 3, cells 302 with touch contact have higher capacitance measurements (e.g., magnitudes of 10, 11) than cells 302 without touch contact (e.g., magnitudes of 00, 01). It will be appreciated that the capacitance measurements also may vary based on the object (e.g., finger, stylus, drinking glass, game piece, alphabet letter) that makes touch contact.

Returning to FIG. 2, the capacitive grid map(s) 206 may include a capacitance value for each touch-sensing pixel of a plurality of touch-sensing pixels of the capacitive touch sensor(s). In some examples, the plurality of touch-sensing pixels includes each touch-sensing pixel of the capacitive touch sensor(s). In other words, capacitance values for the entirety of the capacitive touch sensor may be provided to the OS 204. In other examples, the plurality of touch-sensing pixels of the capacitive grid map 206 includes touch-sensing pixels having a capacitance value that is either less than a negative noise threshold or greater than a positive noise threshold. Each of these touch-sensing pixels may indicate touch input near that touch-sensing pixel. Touch-sensing pixels having capacitance values outside of these thresholds may be omitted from the capacitive grid map, in some examples. In such examples, the plurality of touch-sensing pixels that detect touch input may collectively indicate a touch profile of touch input to the capacitive touch sensor.

The capacitive grid map 206 presents a view of what is actually touching the display, rather than distilled individual touch points. For example, capacitive grid map 300 of FIG. 3 details a user's entire palm print, analogous to if the user had dipped her hand in paint and put it on a piece of paper. The capacitive grid map data 206 may be provided to the OS 204 in a well-defined format, ensuring that the data can be understood by the OS 204. For example, the resolution, bit depth, data structure, and any compression may be consistently implemented so that the OS 204 is able to unambiguously interpret received capacitive grid maps 206.

FIG. 4 shows an example data structure 400 that defines a capacitive grid map, such as capacitive grid map 300 of FIG. 3. In one example, the data structure 400 may be formatted in accordance with a human interface device (HID) standard that may be easily recognizable by the OS 204. The data structure 400 may be formatted in any suitable manner. The data structure 400 includes an index pixel 402 that identifies a first touch-sensing pixel in a sequence of touch-sensing pixels in the set that is being reported. For example, each touch-sensing pixel may have an identifier that indicates a position of the touch-sensing pixel among the plurality of touch-sensing pixels of the touch sensor. The data structure 400 includes a value 404 indicating a total number of touch-input pixels in the sequence, and a value 406 (e.g., 406A, 406B, 406N) indicating a capacitance for each touch-sensing pixel in the sequence. The data structure 400 may support reporting of all pixel values, referred to as flat reporting, or reporting of sequences that have values of interest, referred to as encoded reporting, to the OS 204. Values of interest to the OS 204 may be values either below a negative noise threshold or above a positive noise threshold. In some examples, irrespective of whether flat reporting or encoded reporting is being used, the sensor data being reported for a given frame may be segmented in to smaller micro frames to reduce the size of any given input report as the OS 204 will recompose the frame from the entirety of the micro frames. When utilizing segmented reporting, the digitizer 202 may specify any input report size and the OS 204 may continue to retrieve input reports to compose a frame/capacitive grid map 206.

Once received, the OS 204 may analyze the capacitive grid map 206, via a processing framework 208 to create user experiences. At the most basic level, the OS 204 may output the capacitive grid map 206 to the application(s) 218 executed by the computing system such that the application(s) 218 also may create user experiences based on the full capacitive grid map 206. Further, the OS 204/processing framework 208 may resolve touch points from the capacitive grid map 206 to allow applications 218 to respond to conventional touch and multi-touch scenarios. In some examples, the OS 204 may output separate touch points for the different digitizers 202. For example, the OS 204 may output virtual touch points 212 corresponding to finger touch input to the touch-display, virtual stylus touch points 214 corresponding to stylus touch input to the touch-display, and optionally virtual touchpad touch points 216 corresponding to touch input to an optional touchpad that may be included in the computing system. By allowing the application(s) 218 to access such information, the applications 218 can provide improved user experiences. Moreover, by analyzing the capacitive grid map 206 at the operating system level to extract information about the touch input, the application(s) 218 do not have to perform the same full-blown processing of capacitive grid map 206. Further, the processing framework 208 may holistically consider the capacitive grid map 206 to support other experiences as discussed in further detail below.

The processing framework 208 may be configured to identify various characteristics of the capacitive grid map 206. For example, the processing framework 208 may be configured to identify a touch profile characterizing a shape of touch input to the capacitive touch sensor 202 based on the capacitance values of the capacitive grid map 206. In another example, the processing framework 208 may be configured to identify different sources of touch input based on the capacitance values of the capacitive grid map 206 and/or the identified touch profile. For example, a stylus and a finger may generate different capacitance values in the capacitive grid map that may be identified and used to differentiate touch input from the different sources. In another example, a touch source may be identified based on the shape of the touch profile. For example, a finger touch may be differentiated from a stylus based on having a larger contact region than the stylus. The processing framework 208 may be configured to determine any suitable characteristic of the capacitive grid map 206 that may be used by the OS 204 to create user experiences, such as controlling appropriate graphical output via the display of the computing system.

In some examples, the processing framework 208 may be incorporated with the OS 204 such that the OS 204 may provide at least some to all of the functionality of the processing framework 208.

In some implementations, the processing framework 208 may include a machine-learning capacitive grid map analysis tool 210 configured to classify touch input into different classes defined by different sets of characteristics. The analysis tool 210 may include one or more previously trained, machine-learning classifiers. The analysis tool 210 may be previously-trained using a training set including numerous different previously-generated capacitive grid maps corresponding to different types of touch input. The previously-generated capacitive grid maps may have characteristics that may be distinctive and may be used to distinguish between different capacitive grid maps. During the training process, the analysis tool 210 may develop various profiles or classes of characteristics that may be used to recognize different types of touch input from a capacitive grid map that is being analyzed. In some examples, the analysis tool 210 may be trained to determine that a capacitive grid map has characteristics that match characteristics of the previously-generated capacitive grid maps. The machine-learning analysis tool 210 may recognize any suitable characteristic of a capacitive grid map. Moreover, the analysis tool 210 may match any suitable number of characteristics to determine that a capacitive grid map includes a particular type of touch input. The analysis tool 210 may be configured to classify different portions of the capacitive grid map as being specific types of touch input (e.g., intentional, unintentional, finger, stylus), The analysis tool 210 may be configured according to any suitable machine-learning approach including, but not limited to, decision-tree learning, artificial neural networks, support vector machines, and clustering.

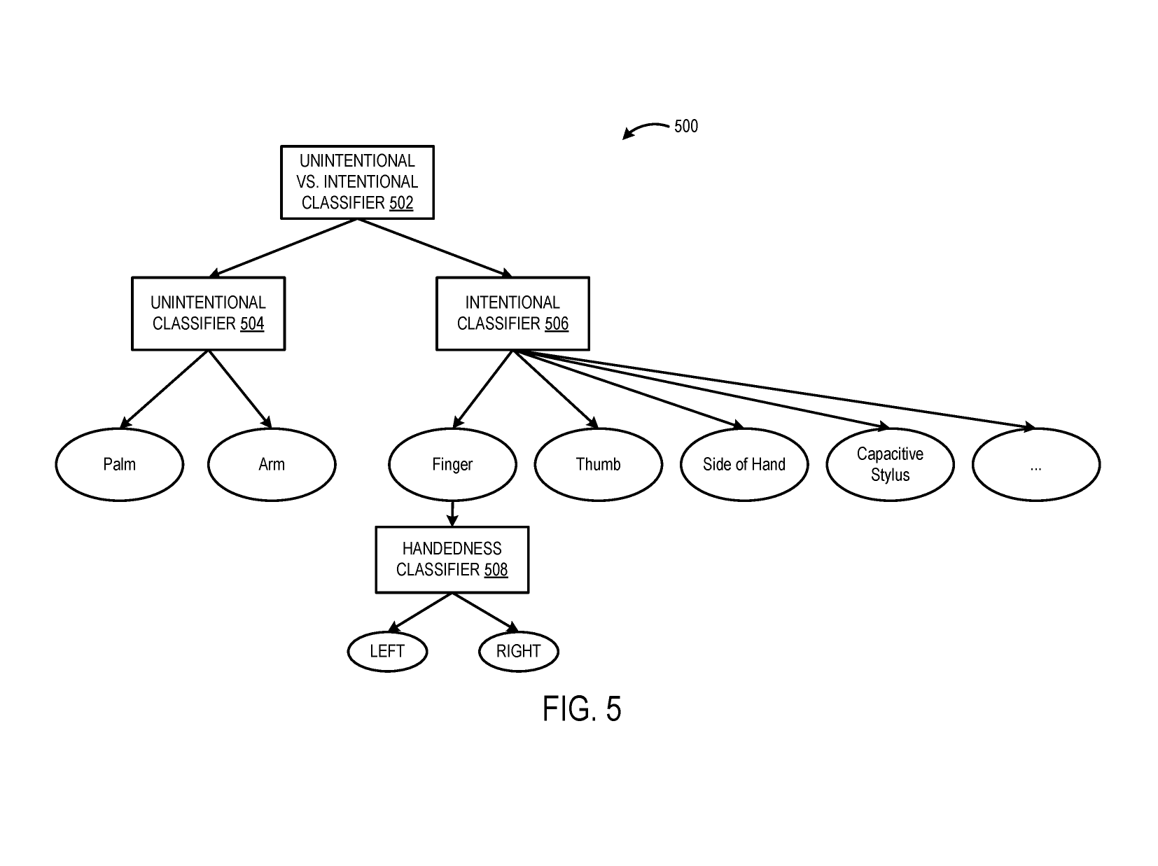

When the analysis tool 210 is utilized to interpret the capacitive grid map 206, the analysis tool 210 may include a plurality of classifiers optionally arranged in a hierarchy. As a nonlimiting example, FIG. 5 shows a hierarchy 500 of machine-learning classifiers that may be included in an analysis tool, such as the analysis tool 210 of FIG. 2. In this example, a top-level classifier 502 is previously trained to determine if a touch is an intentional touch or an unintentional touch. For example, each capacitance value of a touch-sensing pixel of the capacitive grid map that qualifies as touch input (outside of the noise thresholds) may be labeled by the top-level classifier 502 as being unintentional or intentional.

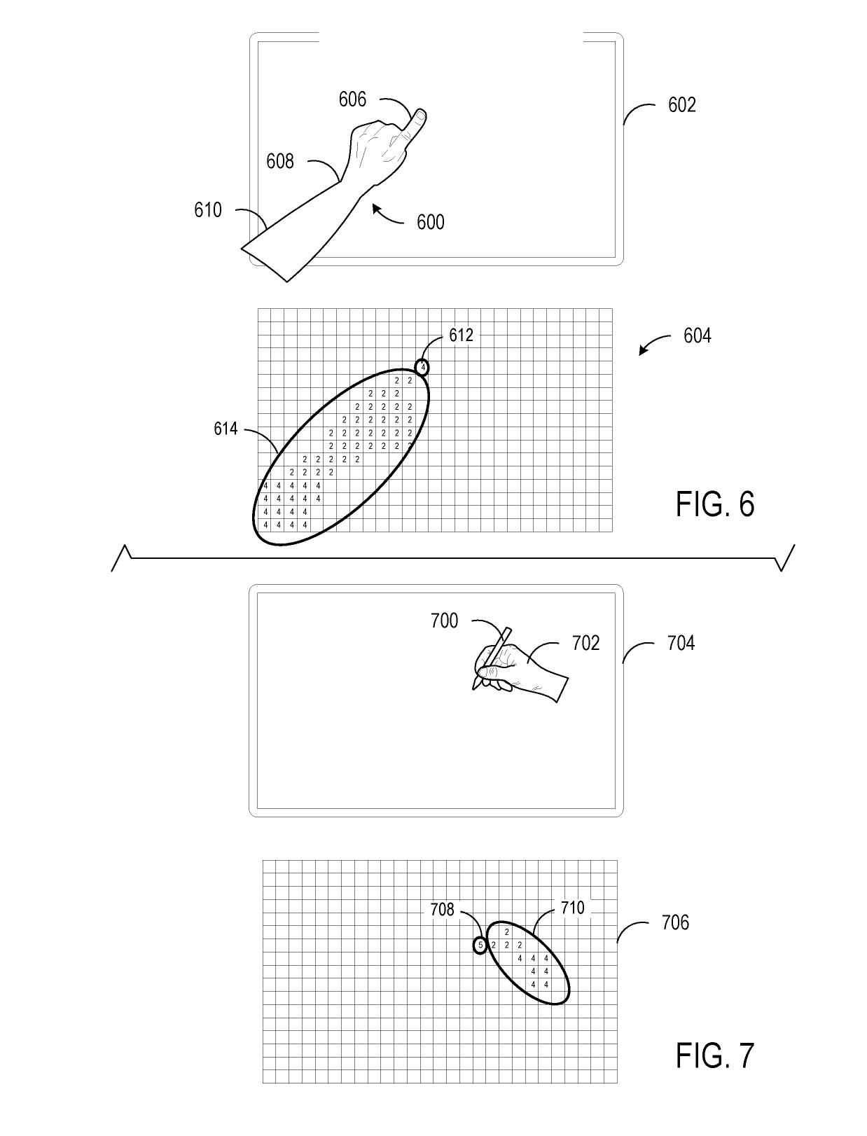

FIGS. 6 and 7 show different example scenarios in which touch input generates capacitive grid maps that include intentional-touch portions and unintentional-touch portions. For example, the analysis tool 210 be used to recognize such intentional-touch portions and unintentional-touch portions. As shown in FIG. 6, a left arm 600 registers touch input to a touch-display 602, which generates a corresponding capacitive grid map 604. The capacitive grid map 604 includes capacitance values from touch-sensing pixels of the touch-display 602 as a result of the touch input provided by the left arm 600. In this example, higher capacitance values represent closer proximity to the touch-sensing pixels and blank pixels represent no touch input. However, in other examples the capacitance values may be represented in the capacitive grid map 604 differently. In particular, touch input provided by an index finger 606 of the left arm 600 is indicated by a touch-sensing pixel having a capacitance value of 4 that indicates contact with the surface of the touch-display 602. Further, a palm and wrist portion 608 of the left arm 600 registers touch input with touch-sensing pixels having a lower capacitance value of 2 indicating that the palm and wrist portion 608 is hovering near the touch-sensing pixels but not contacting the surface of the touch-display 602. Further still, a forearm portion 610 is resting on the surface of the touch-display 602 and registers touch input with touch-sensing pixels having a capacitance value of 4.

The analysis tool 210 may be configured to analyze the capacitive grid map 604 and identify an intentional-touch portion 612 and an unintentional-touch portion 614 based on the capacitive values of each of the touch-sensing pixels. In some examples, the analysis tool 210 may be configured to identify the intentional-touch portion 612 and the unintentional-touch portion 614 based on the shape of the portion of the capacitive grid map that have capacitance values greater that one or more thresholds indicating touch input.

In another example, as shown in FIG. 7, a stylus 700 and a right hand 702 holding the stylus both register touch input to a touch-display 704, which generates a corresponding capacitive grid map 706. In particular, touch input provided by the stylus 700 is indicated by a touch-sensing pixel having a capacitance value of 5. Further, a portion of the right hand 702 that is holding the stylus 700 registers with touch-sensing pixels having a lower capacitance value of 2 indicating that the portion of the right hand is hovering near the touch-sensing pixels but not contacting the surface of the touch-display 704. Further still, a palm portion of the right hand 702 is resting on the surface of the touch-display 704 and registers touch input with touch-sensing pixels having a capacitance value of 4. In this example, the stylus 700 may generate a capacitance value that differs from any capacitance value generated by the right hand 702 and that may be unable to be generated in any way by the right hand 702. In this way, the two different sources of touch input may be differentiated from each other. In other examples, size, shape, and/or other touch attributes may be used to differentiate a stylus touch from a finger/hand touch.

The analysis tool 210 may be configured to analyze the capacitive grid map 706 and identify an intentional-touch portion 708 provided by the stylus 700 and an unintentional-touch portion 710 provided by the right hand 702 based on the capacitive values of each of the touch-sensing pixels and/or one or more attributes derived from the capacitive values.

Returning to FIG. 5, if the top-level classifier 502 determines a touch is unintentional, a second-level classifier 504 is invoked. Second-level classifier 504 is previously trained to determine if the unintentional touch is a palm touch or an arm touch. The different types of unintentional touches may be used by the OS 204 to determine different user interactions and provide appropriate responses. For example, the determination that an unintentional touch is an arm or a palm may be used by the OS 204 to adjust presentation of a user interface object to avoid being occluded by the arm or the palm. In another example, the determination that an unintentional touch is a palm may be used by the OS 204 to determine a manner in which a user is gripping the computing device/display and adjust presentation of a user interface object based on that particular grip/orientation of the computing device. The different types of intentional touches may be used by the OS 204 to determine different user interactions and provide appropriate responses.

If top-level classifier 502 determines a touch is intentional, a different second-level classifier 506 is invoked. Second-level classifier 506 is previously trained to determine if the intentional touch is a finger touch, thumb touch, side-of-hand touch, stylus touch, or another type of touch. In some implementations, the second-level classifier 506 may including additional sub-hierarchies of multiple classifiers that are each previously trained to determine whether a touch input is a particular type of touch input or from a particular source. The different types of intentional touches may be used by the OS 204 to determine different user interactions and provide appropriate responses. For example, the OS 204 may provide different responses based on whether a finger touch or a stylus touch is provided as input. As another example, the OS 204 may recognize different types of gestures that are specific to the identified type of intentional touch input.

If the second-level classifier 506 determines that the intentional touch is an intentional finger touch, then a third-level classifier 508 is invoked. The third-level classifier 508 is previously trained to determine if the intentional finger touch is a left-handed finger touch or a right-handed finger touch. The OS 204 may use the handedness of the touch to provide an appropriate response to the touch input. For example, the OS 204 may shift user interface objects on the display to not be occluded by a palm of the hand providing the touch.

The classifier hierarchy may increase compute efficiency, because only classifiers in a specific branch will run, thus avoiding unnecessary computations/classifications.

The illustrated example classifier hierarchy 500 is not limiting. The hierarchy 500 may include any suitable number of different levels, and any suitable number of classifiers at each level. For example, alternative or additional classifiers may be implemented at any level of the hierarchy 500.

Returning to FIG. 2, the OS 204 may use the machine-learning capacitive grid map analysis tool 210 to extract various characteristics (e.g., unintentional/intentional, touch source type) of touch input from the capacitive grid map 206. In some examples, the OS 204 may be configured to recognize one or more gestures based on the output of the analysis tool 210 and/or other touch input characteristics of the capacitive grid map 206. In other examples, the OS 204 may pass the capacitive grid map 206 and/or determined touch input information to one or more application(s) 218. In some examples, such application(s) 218 may be configured to perform gesture recognition based on such information. The OS 204 may be configured to perform various operations based on gestures recognized from the capacitive grid map(s) 206. For example, the OS 204 may adjust presentation of a user interface object based on a recognized gesture.

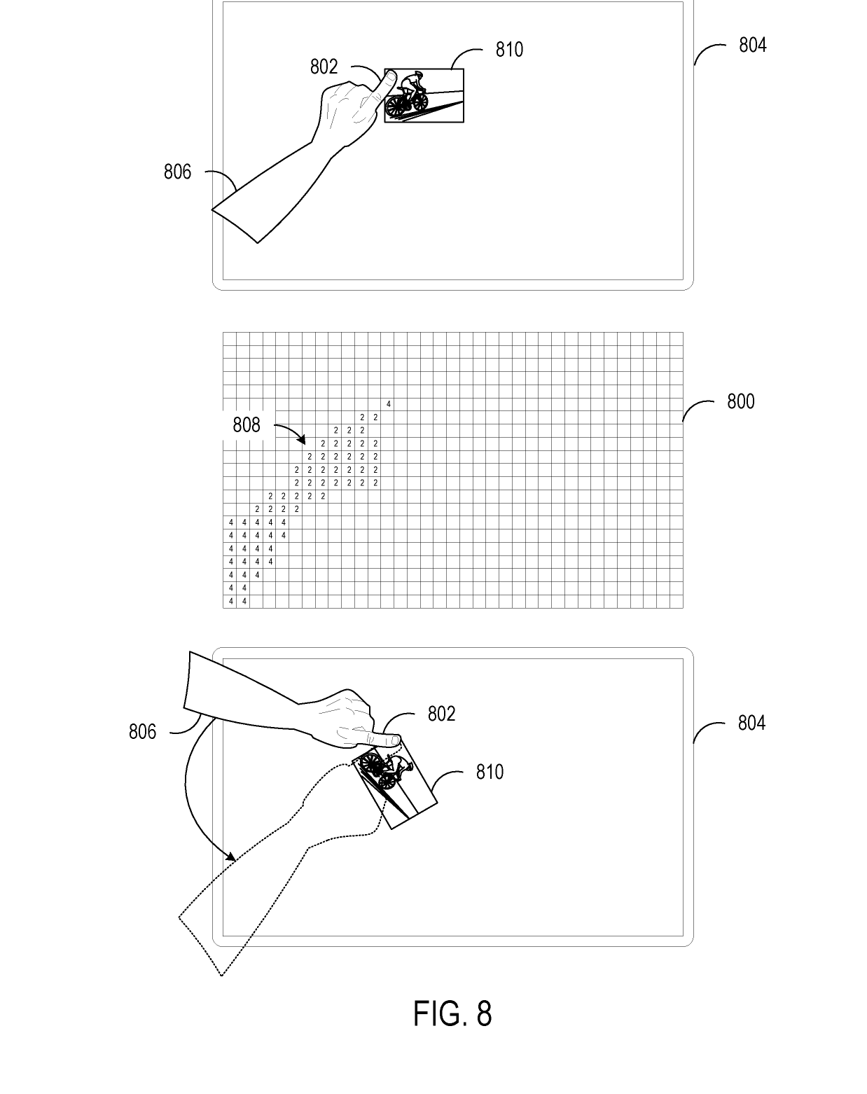

A full capacitive grid map enables new gestures that depend on the size and/or shape of the touch contact, as well as the capacitive properties of the source providing the touch input. In an example shown in FIG. 8, the OS 204 may use a capacitive grid map 800 to determine a directionality of a single finger 802 providing touch input to a touch-display 804. For example, the OS 204 may analyze a touch profile 808 of capacitance values formed from the touch input provided by the finger 802 and an associated arm 806. In some examples, the OS 204 may determine that the single finger 802 is providing intentional touch input while the rest of the associated arm 806 is providing unintentional touch input. However, the OS 204 may use the information provided by the unintentional touch input to determine the handedness of the single finger 802 and further a direction of the single finger 802 by analyzing a touch profile 808 of the associated arm 806 in the capacitive grid map 800. Such information may enable the OS 204 to recognize a rotation gesture based on the touch input of the single finger 802, and determine a direction of rotation of the rotation gesture. For example, this gesture may be used to adjust presentation of a user interface object by rotating the user interface object only using a single finger. In the illustrated example, the single finger 802 is placed on a digital image 810 presented via the touch-display 804. When the single finger 802 rotates, the OS 204 may determine the change in position of the associated arm 806 from the capacitive grid map 800, determine the rotation of the single finger 802 from the change in position of the associated arm 806, and rotate the digital image 810 based on the rotation of the single finger 802. Such operation may be used, for example, in a scrapbooking application to allow a user to place pictures with particular orientations. Such single finger direction detection may allow a user to avoid having to use sometimes difficult two-finger gestures.

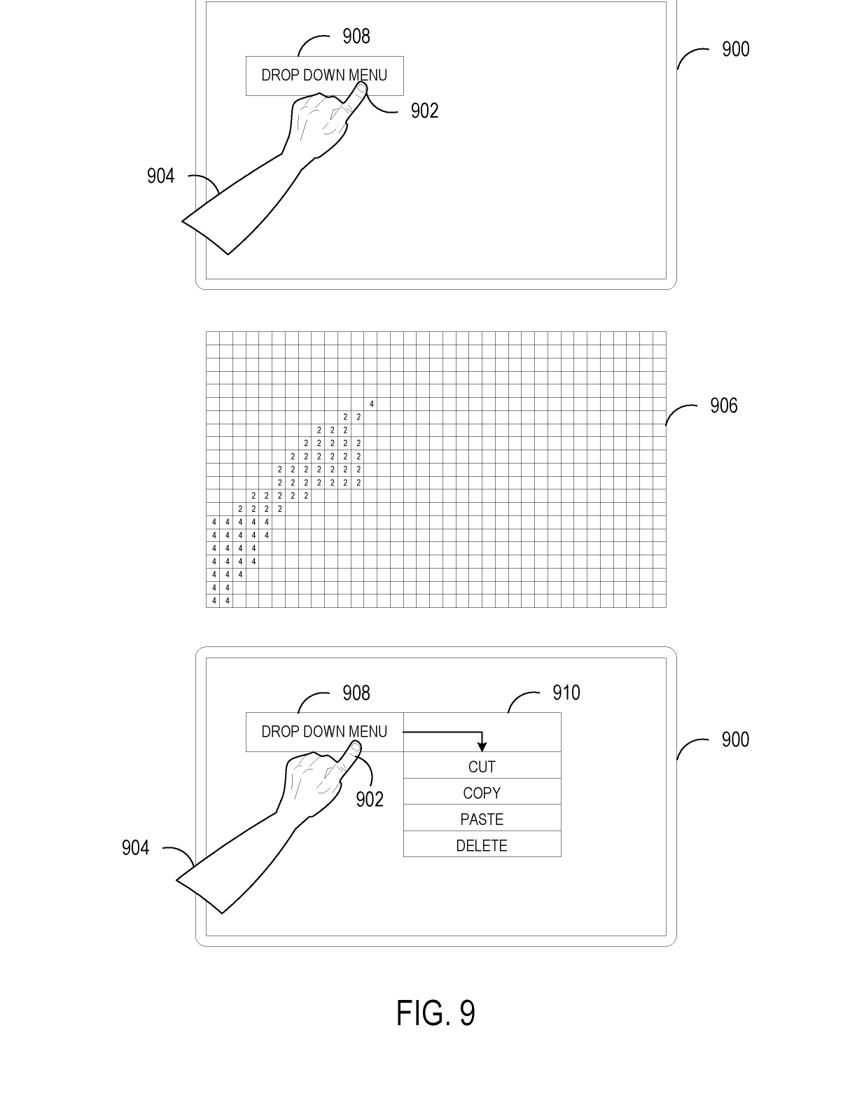

Exposure to the full capacitive grid map also allows the OS and/or applications to support more nuanced experience optimizations by virtue of understanding how a user is interacting with a device. In an example shown in FIG. 9, when a user is providing touch input to a touch-display 900 via a finger 902, a natural user posture is to rest an arm 904 on the touch-display 900 while providing the touch input. In other approaches where the full capacitive grid map is not exposed to the OS, input corresponding to the resting arm 904 is never exposed to the OS, and thus the OS and/or other application have no way of knowing that the arm is there. Thus, the OS and/or applications are more likely to display important user interface elements directly under the arm such that the user interface element(s) are occluded from the user's view. However, by exposing a full capacitive grid map 906 generated based on touch input from the finger 902 and the arm 904, the area of the touch-display 900 that is covered can be communicated to the OS/applications. As such, the OS/applications may adjust the position of the user interface object(s) to avoid being occluded by the user's arm 904.

In the illustrated example, the finger 902 touches a user interface object in the form of a drop-down menu 908. The OS 204 may identify the unintentional touch portion of the user's arm 904 resting on the touch-display 900 from the capacitive grid map 906 and adjust presentation of the drop-down menu 908 to a position on the touch-display 900 that is not occluded by the unintentional-touch portion of the user's arm 904. In particular, the drop-down menu 908 displays a list of menu options to the right of the user's arm 904.

Further, the OS and/or applications can more intelligently place user interface elements based on the directionality of the user's finger. In the illustrated example, the user invokes the drop-down menu 908 with a left-hand finger, and the OS 204 may adjust the user interface and display the menu options to the right of the interaction so as not to display important user interface elements under the user's hand. In other words, the OS 204 may be configured to determine a handedness of the finger providing the touch input based on the capacitive grid map, and adjust presentation the drop-down menu based on the handedness of the finger touch input.

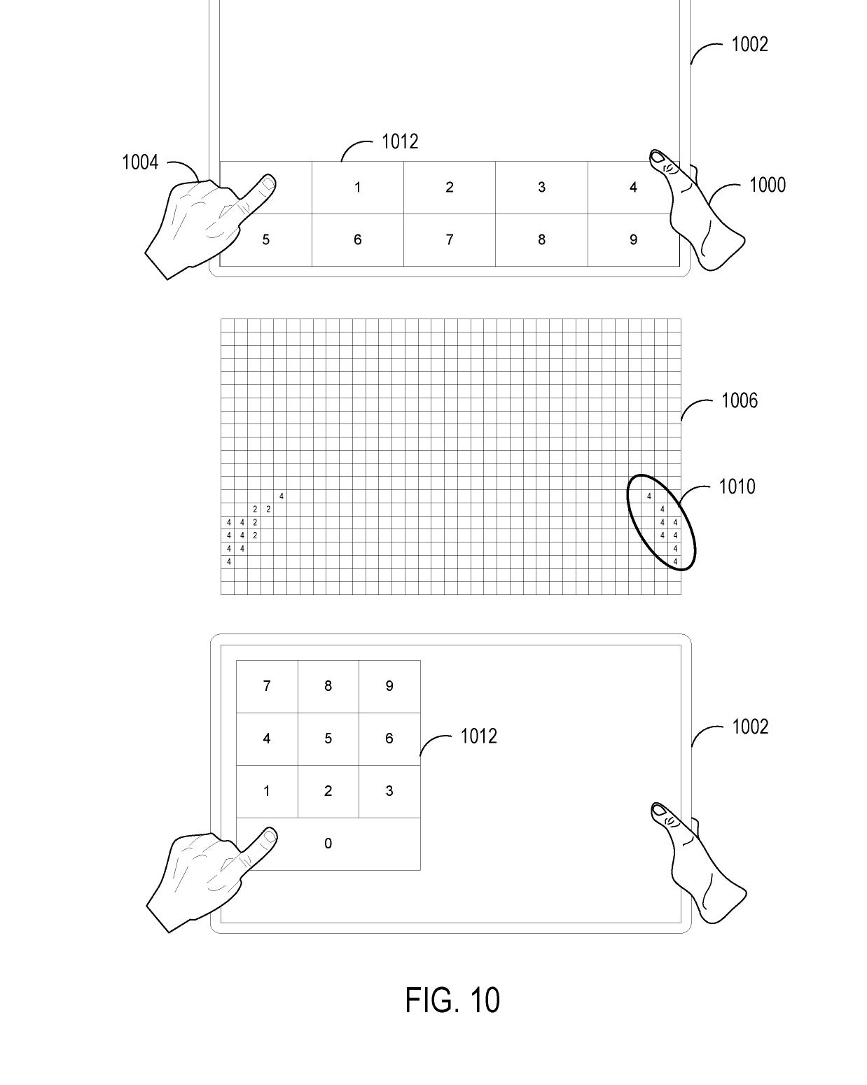

The full capacitive grid map may also be used to understand how a user is gripping a touch-display. In an example shown in FIG. 10, a right hand 1000 grips a touch-display 1002 to hold the touch-display while a left hand 1004 provides touch input to the touch-display 1002. The OS 204 may be configured to identify the hand that is gripping the capacitive touch-display based on a capacitive grid map 1006. For example, the OS 204 may recognize capacitive grid map “blooms” 1010 visible on the portions of the touch-display 1002 contacted by the thumb and palm of the right hand 1000. The OS 204 may distinguish the touch input of the right hand 1000 from the touch input of the left hand 1004. Further, the OS 204 may recognize the touch input of the left hand 1004 as intentional touch input and the touch input of the right hand 1000 as unintentional touch input. Based on such analysis, the OS 204 may adjust presentation of the user interface object based on the grip hand. In the illustrated example, the OS 204 moves a virtual keypad 1012 to a position on the touch-display 1002 that is not occluded by the grip hand 1000. Additionally, the OS 204 rearranges the virtual keypad 1012 to be more easily controlled via one-handed, left-hand operation. In particular, the virtual keys of the virtual keypad 1012 are arranged more vertically and less horizontally. According to such a configuration, the OS and/or applications may automatically place user interface elements, such as the virtual keypad 1012, in a position based on how the user is actually holding the device. Further still, different user's may have different signature grips, and recognition of such grips may be used to provide individualized experiences, such as different/personalized user interface arrangements.

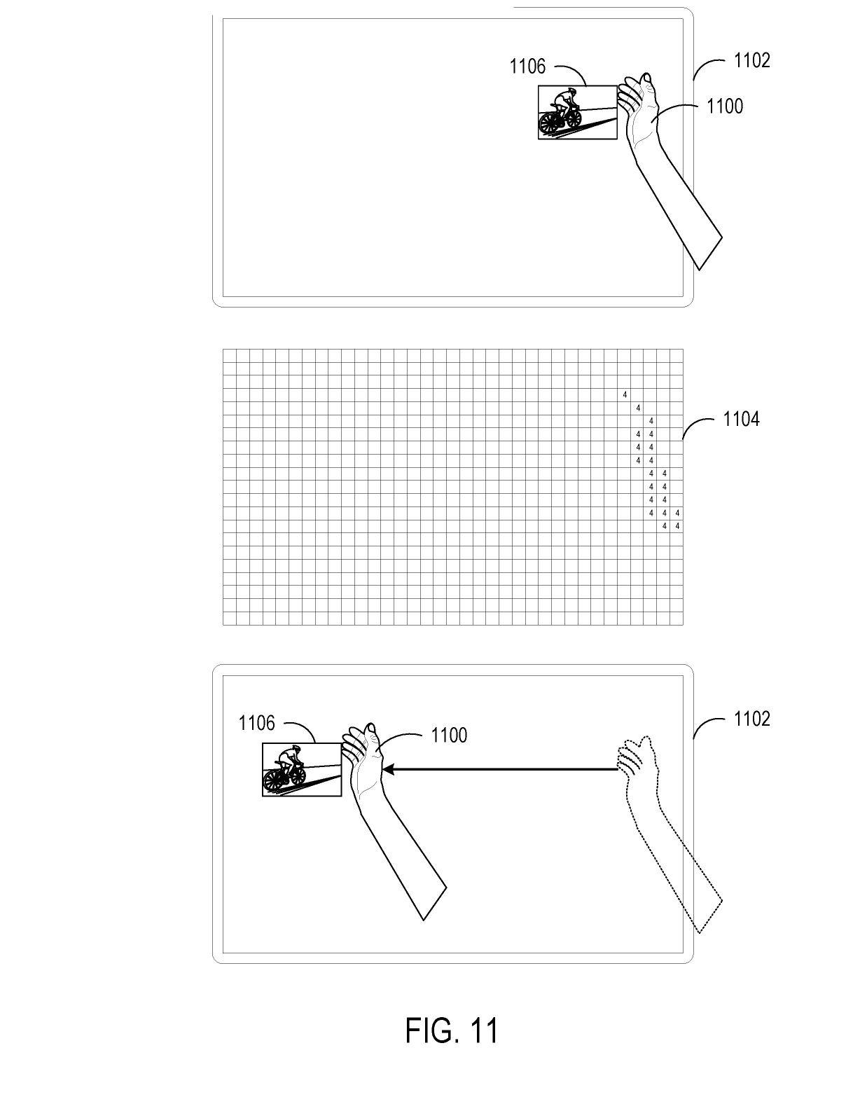

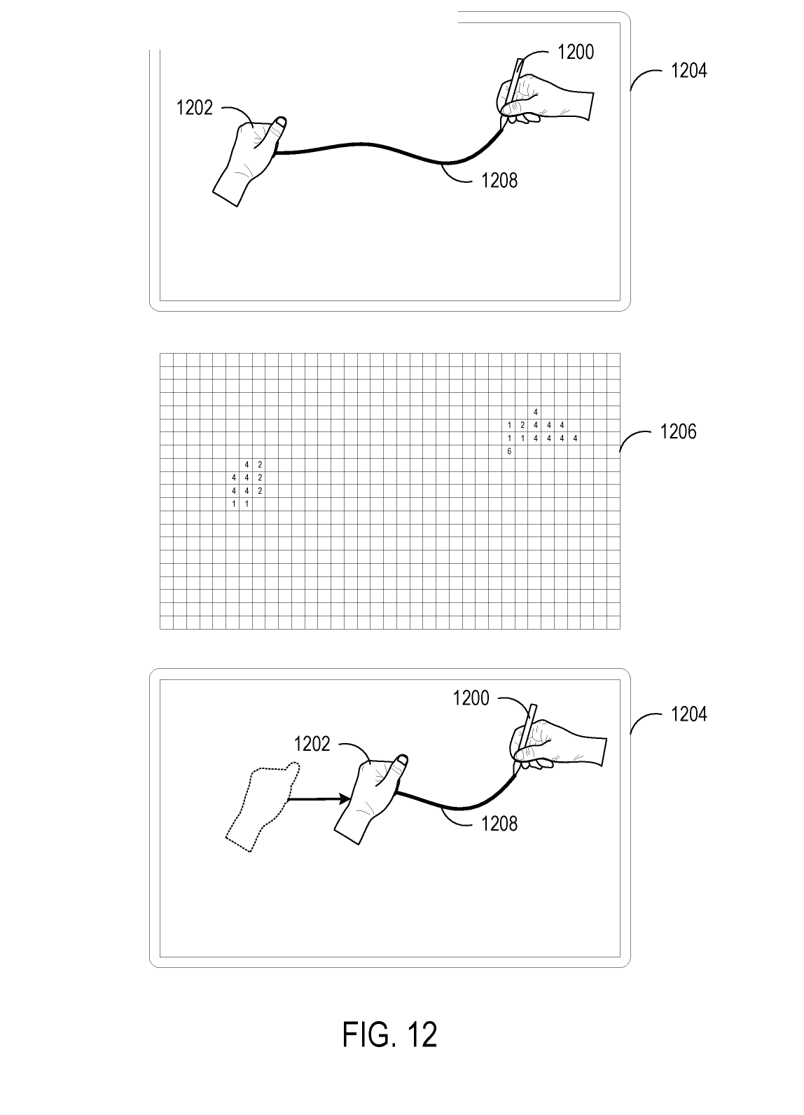

As another example, exposure to a full capacitive grid map allows the OS 204 to detect when a user has placed the side of her hand on a touch-display as intentional touch input. The OS 204 may recognize different gestures and may perform various types of actions responsive to these type of gestures. In an example shown in FIG. 11, when a user places a side of her hand 1100 on the touch-display 1102, the OS 204 identifies a side of a hand touch profile from the capacitive grid map 1104. As the side of hand 1100 moves along the touch-display 1102, the OS 204 may recognize a swipe gesture based on the side of the hand touch profile from the capacitive grid map 1104. In this example, the OS 204 translates a user interface object in the form of a digital image 1106 on the display based on the swipe gesture. For example, such operation may be implemented in digital photography application to enhance touch interaction with digital photographs.

As another example, exposure to the full capacitive grid map allows different touch input sources to be differentiated from one another. For example, different objects (e.g., finger or stylus) can predictably cause different capacitance measurements, which may be detailed in the capacitive grid map and recognized by the OS 204. As such, the operating system and/or applications may be programmed to behave differently based on whether a finger, capacitive stylus, or other object is touching the screen. In an example shown in FIG. 12, a stylus 1200 and a side of a left hand 1202 may provide touch input to a touch-display 1204. The OS 204 may differentiate between the two different touch input sources based on the different capacitance values generated in the capacitive grid map 1206. The OS 204 may adjust presentation of user interface objects on the touch-display 1204 differently based on the touch input provided by the different sources. In particular, the stylus 1200 causes inking that produces an ink trace 1208 and the side of hand 1202 causes erasing of the ink trace 1208. In another example, on an inking canvas, an application may be programmed to scroll the canvas responsive to a finger swipe, and to ink on the canvas responsive to a stylus swipe. In still another example, on an inking canvas, an application may be programmed to scroll the canvas responsive to a finger swipe, and to erase ink on the canvas based on a side of hand swipe. These type of experiences are not possible unless a finger, a side of hand, a stylus, and other types of touch input can be differentiated from one another.

In general, the rich information provided by a capacitive grid map allows the OS and/or applications to differentiate between various capacitive objects placed on the screen. As another example, an educational application can be programmed to differentiate between different alphabet objects that are placed on the screen. As yet another example, objects with unique and/or variable capacitive signatures, such as a capacitive paintbrush, may be supported. Using the capacitive grid map data, a realistic interpretation of such a paint brush's interaction with the screen can be determined, thus allowing richer experiences. In another example, the capacitive grid map enables detecting when a user's entire hand is flat on the screen or the ball of a user's first is pressed against the screen, and the OS may perform various operations based on recognizing these types of touch input and/or gestures, such as invoking a system menu, muting sound, turning the screen off, etc.

The hardware and scenarios described herein are not limited to capacitive touch-displays, as capacitive touch sensors, without display functionality, may also provide full capacitive grid maps to an operating system or application. The same principles of receiving and processing a capacitive grid map apply to a touchpad. A full capacitive grid map enables better algorithms to be crafted for palm rejection, preventing accidental activations, and supporting advanced gestures.

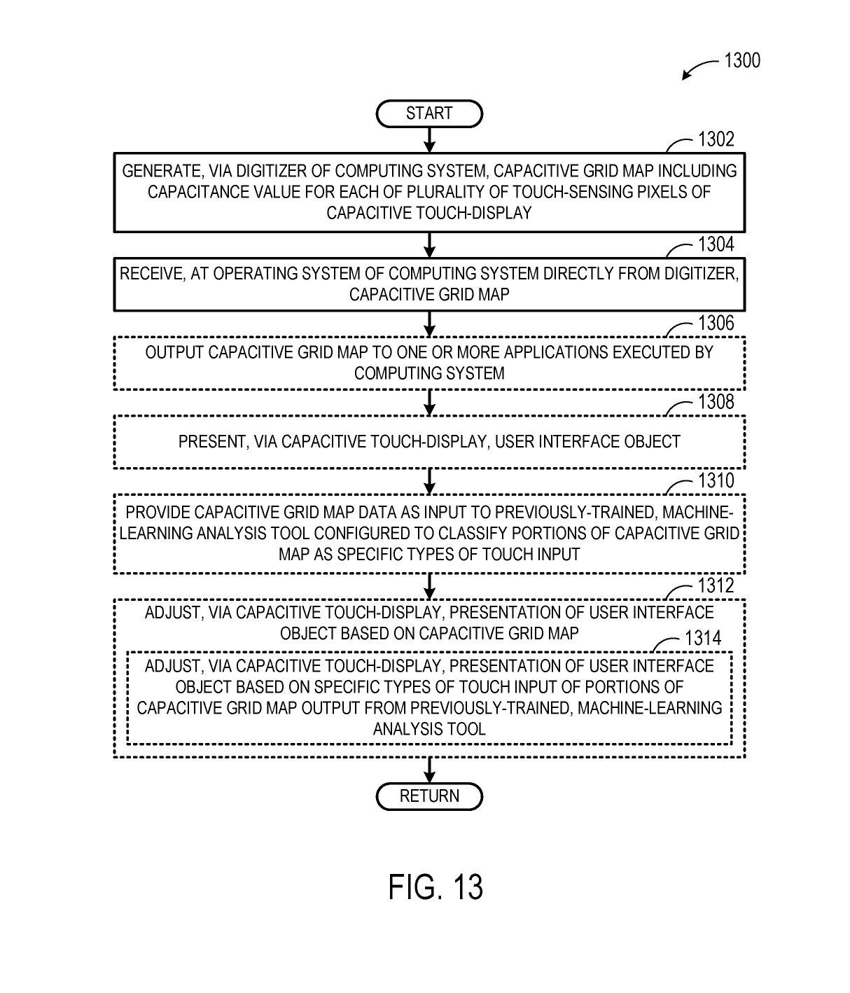

FIG. 13 shows an example method 1300 for controlling operation of a computing system based on a capacitive grid map. For example, the method 1300 may be performed by the computing system 100 of FIG. 1 or the computing system 1400 of FIG. 14.

At 1302, the method 1300 includes generating, via a digitizer of the computing system, a capacitive grid map including a capacitance value for each of a plurality of touch-sensing pixels of a capacitive touch-display. At 1304, the method 1300 includes receiving, at an operating system of the computing system directly from the digitizer, the capacitive grid map.

In some implementations, at 1306, the method 1300 optionally may include outputting the capacitive grid map from the operating system to one or more applications executed by the computing system.

In some implementations, at 1308, the method 1300 optionally may include presenting, via a capacitive touch-display, a user interface object. In some implementations, at 1310, the method 1300 optionally may include providing capacitive grid map data as input to a previously-trained, machine-learning analysis tool configured to classify portions of the capacitive grid map as specific types of touch input. In some implementations, at 1312, the method 1300 optionally may include adjusting, via the capacitive touch-display, presentation of a user interface object based on the capacitive grid map. In some implementations, at 1314, the method 1300 optionally may include adjusting, via the capacitive touch-display, presentation of a user interface object based on the specific types of touch input of the portions of the capacitive grid map output from the previously-trained, machine-learning analysis tool.

In some implementations, the methods and processes described herein may be tied to a computing system of one or more computing devices. In particular, such methods and processes may be implemented as a computer-application program or service, an application-programming interface (API), an OS framework, library, and/or other computer-program product.

FIG. 14 schematically shows a non-limiting implementation of a computing system 1400 that can enact one or more of the methods and processes described above. Computing system 1400 is shown in simplified form. Computing system 1400 may take the form of one or more personal computers, server computers, tablet computers, home-entertainment computers, network computing devices, gaming devices, mobile computing devices, mobile communication devices (e.g., smart phone), and/or other computing devices. For example, computing system 100 is an example of computing system 1400.

Computing system 1400 includes a logic machine 1402 and a storage machine 1404. Computing system 1400 may optionally include a touch-display subsystem, touch input subsystem, communication subsystem, and/or other components not shown in FIG. 14.

Logic machine 1402 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1404 includes one or more physical devices configured to hold instructions executable by the logic machine to implement the methods and processes described herein. When such methods and processes are implemented, the state of storage machine 1404 may be transformed—e.g., to hold different data.

Storage machine 1404 may include removable and/or built-in devices. Storage machine 1404 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1404 may include volatile, nonvolatile, dynamic, static, read/write, read-only, random-access, sequential-access, location-addressable, file-addressable, and/or content-addressable devices.

It will be appreciated that storage machine 1404 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1402 and storage machine 1404 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1400 implemented to perform a particular function. In some cases, a module, program, or engine may be instantiated via logic machine 1402 executing instructions held by storage machine 1404. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, the display subsystem may be used to present a visual representation of data held by storage machine 1404. This visual representation may take the form of a graphical user interface (GUI). As the herein described methods and processes change the data held by the storage machine, and thus transform the state of the storage machine, the state of the display subsystem may likewise be transformed to visually represent changes in the underlying data. The display subsystem may include one or more display devices utilizing virtually any type of technology. Such display devices may be combined with logic machine 1402 and/or storage machine 1404 in a shared enclosure, or such display devices may be peripheral display devices.

When included, the input subsystem may comprise or interface with one or more user-input devices such as a keyboard, mouse, touch screen, touch pad, or game controller. In some implementations, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, the communication subsystem may be configured to communicatively couple computing system 1400 with one or more other computing devices. The communication subsystem may include wired and/or wireless communication devices compatible with one or more different communication protocols. As non-limiting examples, the communication subsystem may be configured for communication via a wireless telephone network, or a wired or wireless local- or wide-area network. In some implementations, the communication subsystem may allow computing system 1400 to send and/or receive messages to and/or from other devices via a network such as the Internet.

In an example, a computing system comprises a capacitive touch-display including a plurality of touch-sensing pixels, a digitizer configured to generate a capacitive grid map including a capacitance value for each of the plurality of touch-sensing pixels, and an operating system configured to receive the capacitive grid map directly from the digitizer. In this example and/or other examples, the plurality of touch-sensing pixels may include each touch-sensing pixel of the capacitive touch-display. In this example and/or other examples, the plurality of touch-sensing pixels may include touch-sensing pixels having a capacitance value that is either less than a negative noise threshold or greater than a positive noise threshold. In this example and/or other examples, the operating system may be configured to output the capacitive grid map from the operating system to one or more applications executed by the computing system. In this example and/or other examples, the capacitive grid map may be defined by a data structure formatted in accordance with a human interface device (HID) format recognizable by the operating system, the data structure may include an index pixel that identifies a first touch-sensing pixel in a sequence, a total number of touch-input pixels in the sequence, and a capacitance value for each touch-input pixel in the sequence. In this example and/or other examples, the capacitive touch-display may be configured to present a user interface object, and the operating system may be configured to adjust, via the capacitive touch-display, presentation of the user interface object based on the capacitive grid map. In this example and/or other examples, the operating system may be configured to provide capacitive grid map data as input to a previously-trained, machine-learning analysis tool configured to classify portions of the capacitive grid map as specific types of touch input and adjust presentation of the user interface object based on the specific types of touch input. In this example and/or other examples, the operating system may be configured to identify a single finger touch input based on the capacitive grid map, recognize a rotation gesture based on the single finger touch input, determine a direction of rotation of the rotation gesture, and rotate the user interface object in the direction of rotation based on the rotation gesture. In this example and/or other examples, the operating system may be configured to identify an intentional-touch portion and an unintentional-touch portion of the capacitive grid map, and adjust presentation of the user interface object to a position on the capacitive touch-display that is not occluded by the unintentional-touch portion. In this example and/or other examples, the operating system may be configured to identify a finger touch input based on the capacitive grid map, determine a handedness of the finger touch input, and adjust presentation the user interface object based on the handedness of the finger touch input. In this example and/or other examples, the operating system may be configured to identify a grip hand that is gripping the capacitive touch-display based on the capacitive grid map, and adjust presentation of the user interface object based on the grip hand. In this example and/or other examples, the operating system may be configured to identify a stylus-touch portion and a finger-touch portion of the capacitive grid map, adjust presentation of the user interface object based on the stylus-touch portion and adjust presentation of the user interface object differently based on the finger-touch portion.

In an example, a method for controlling operation of a computing system comprises generating, via a digitizer of the computing system, a capacitive grid map including a capacitance value for each of a plurality of touch-sensing pixels of a capacitive touch-display, and receiving, at an operating system of the computing system directly from the digitizer, the capacitive grid map. In this example and/or other examples, the method may further comprise presenting, via the capacitive touch-display, a user interface object, and adjusting, via the capacitive touch-display, presentation of the user interface object based on the capacitive grid map. In this example and/or other examples, the method may further comprise providing capacitive grid map data as input to a previously-trained, machine-learning analysis tool configured to classify portions of the capacitive grid map as specific types of touch input, and adjusting, via the capacitive touch-display, presentation of the user interface object based on the specific types of touch input. In this example and/or other examples, the method may further comprise identifying, via the operating system, an intentional-touch portion and an unintentional-touch portion of the capacitive grid map, and adjusting, via the capacitive touch-display, presentation of the user interface object based on the capacitive grid map such that a position of the user interface object does not overlap with the unintentional-touch portion on the capacitive touch-display. In this example and/or other examples, the method may further comprise identifying a stylus-touch portion and a finger-touch portion of the capacitive grid map, adjusting, via the capacitive touch-display, presentation of the user interface object based on the stylus-touch portion, and adjusting, via the capacitive touch-display, presentation of the user interface object differently based on the finger-touch portion.

In an example, a computing system, comprises a capacitive touch-display including a plurality of touch-sensing pixels, a digitizer configured to generate a capacitive grid map including a capacitance value for each of the plurality of touch-sensing pixels, and an operating system configured to receive the capacitive grid map directly from the digitizer, identify an intentional-touch portion and an unintentional-touch portion of the capacitive grid map, and present, via the capacitive touch-display, a user interface object based on the intentional-touch portion such that a position of the user interface object does not overlap with the unintentional-touch portion on the capacitive touch-display. In this example and/or other examples, the operating system may be configured to provide capacitive grid map data as input to a previously-trained, machine-learning analysis tool configured to classify portions of the capacitive grid map as the unintentional-touch portion and the intentional-touch portion. In this example and/or other examples, the operating system may be configured to identify a stylus-touch portion and a finger-touch portion of the capacitive grid map, adjust presentation of the user interface object based on the stylus-touch portion and adjust presentation of the user interface object differently based on the finger-touch portion.

It will be understood that the configurations and/or approaches described herein are exemplary in nature, and that these specific implementations or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
a capacitive touch-display including a plurality of touch-sensing pixels;
a digitizer configured to generate a capacitive grid map including a capacitance value for each of the plurality of touch-sensing pixels; and
an operating system configured to receive the capacitive grid map directly from the digitizer.

2. The computing system of claim 1, wherein the plurality of touch-sensing pixels includes each touch-sensing pixel of the capacitive touch-display.

3. The computing system of claim 1, wherein the plurality of touch-sensing pixels includes touch-sensing pixels having a capacitance value that is either less than a negative noise threshold or greater than a positive noise threshold.

4. The computing system of claim 1, wherein the operating system is configured to output the capacitive grid map from the operating system to one or more applications executed by the computing system.

5. The computing system of claim 1, wherein the capacitive grid map is defined by a data structure formatted in accordance with a human interface device (HID) format recognizable by the operating system, the data structure including an index pixel that identifies a first touch-sensing pixel in a sequence, a total number of touch-input pixels in the sequence, and a capacitance value for each touch-input pixel in the sequence.

6. The computing system of claim 1, wherein the capacitive touch-display is configured to present a user interface object, and wherein the operating system is configured to adjust, via the capacitive touch-display, presentation of the user interface object based on the capacitive grid map.

7. The computing system of claim 6, wherein the operating system is configured to provide capacitive grid map data as input to a previously-trained, machine-learning analysis tool configured to classify portions of the capacitive grid map as specific types of touch input and adjust presentation of the user interface object based on the specific types of touch input.

8. The computing system of claim 6, wherein the operating system is configured to identify a single finger touch input based on the capacitive grid map, recognize a rotation gesture based on the single finger touch input, determine a direction of rotation of the rotation gesture, and rotate the user interface object in the direction of rotation based on the rotation gesture.

9. The computing system of claim 6, wherein the operating system is configured to identify an intentional-touch portion and an unintentional-touch portion of the capacitive grid map, and adjust presentation of the user interface object to a position on the capacitive touch-display that is not occluded by the unintentional-touch portion.

10. The computing system of claim 6, wherein the operating system is configured to identify a finger touch input based on the capacitive grid map, determine a handedness of the finger touch input, and adjust presentation the user interface object based on the handedness of the finger touch input.

11. The computing system of claim 6, wherein the operating system is configured to identify a grip hand that is gripping the capacitive touch-display based on the capacitive grid map, and adjust presentation of the user interface object based on the grip hand.

12. The computing system of claim 6, wherein the operating system is configured to identify a stylus-touch portion and a finger-touch portion of the capacitive grid map, adjust presentation of the user interface object based on the stylus-touch portion and adjust presentation of the user interface object differently based on the finger-touch portion.

13. A method for controlling operation of a computing system, the method comprising:
generating, via a digitizer of the computing system, a capacitive grid map including a capacitance value for each of a plurality of touch-sensing pixels of a capacitive touch-display; and
receiving, at an operating system of the computing system directly from the digitizer, the capacitive grid map.

14. The method of claim 13, further comprising:
presenting, via the capacitive touch-display, a user interface object, and
adjusting, via the capacitive touch-display, presentation of the user interface object based on the capacitive grid map.

15. The method of claim 13, further comprising:
providing capacitive grid map data as input to a previously-trained, machine-learning analysis tool configured to classify portions of the capacitive grid map as specific types of touch input; and
adjusting, via the capacitive touch-display, presentation of the user interface object based on the specific types of touch input.

16. The method of claim 13, further comprising:
identifying, via the operating system, an intentional-touch portion and an unintentional-touch portion of the capacitive grid map; and
adjusting, via the capacitive touch-display, presentation of the user interface object based on the capacitive grid map such that a position of the user interface object does not overlap with the unintentional-touch portion on the capacitive touch-display.

17. The method of claim 13, further comprising:
identifying a stylus-touch portion and a finger-touch portion of the capacitive grid map;
adjusting, via the capacitive touch-display, presentation of the user interface object based on the stylus-touch portion; and
adjusting, via the capacitive touch-display, presentation of the user interface object differently based on the finger-touch portion.

18. A computing system, comprising:
a capacitive touch-display including a plurality of touch-sensing pixels;
a digitizer configured to generate a capacitive grid map including a capacitance value for each of the plurality of touch-sensing pixels; and
an operating system configured to:
receive the capacitive grid map directly from the digitizer,
identify an intentional-touch portion and an unintentional-touch portion of the capacitive grid map, and
present, via the capacitive touch-display, a user interface object based on the intentional-touch portion such that a position of the user interface object does not overlap with the unintentional-touch portion on the capacitive touch-display.

19. The computing system of claim 18, wherein the operating system is configured to provide capacitive grid map data as input to a previously-trained, machine-learning analysis tool configured to classify portions of the capacitive grid map as the unintentional-touch portion and the intentional-touch portion.

20. The computing system of claim 18, wherein the operating system is configured to identify a stylus-touch portion and a finger-touch portion of the capacitive grid map, adjust presentation of the user interface object based on the stylus-touch portion and adjust presentation of the user interface object differently based on the finger-touch portion.
